(19) United States
(12) Patent Application Publication
(10) Pub. No.: US 2005/0070415 A1
(43) Pub. Date: Mar. 31, 2005

(54) Assembly for and method of preventing buildup of debris in a folding roll tucker assembly

(76) Inventor: Andrew L. Haasl, Green Bay, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/952,680

(22) Filed: Sep. 29, 2004

Related U.S. Application Data
(60) Provisional application No. 60/507,404, filed on Sep. 30, 2003.

(51) Int. Cl. B31F 1/10

(52) U.S. Cl. 493/424

(57) ABSTRACT

An interfolding machine includes a folding roll having a tucker assembly configured to interact with a gripper assembly of an adjacent folding roll for gripping and folding a sheet of material into a zig-zagged stack. The tucker assembly includes a tucker positioned in a cavity or slot in the folding roll. The tucker assembly further includes an axial air supply passage disposed along a central axis of the folding roll, and an outwardly extending passage extending from the axial air supply passage to the cavity. The axial air supply passage is configured to receive and communicate a flow of air to the outwardly extending passage, which is configured to direct the flow of air in a radial outward direction along the cavity. The disposition of the tucker in the cavity is configured to create positive air pressure around the tucker so as to inhibit dust and debris from contaminating the components of the tucker assembly.

### RELATED APPLICATIONS

This application claims the benefit under 35 U.S.C. § 119(e) of U.S. Provisional Application Ser. No. 60/507,404, filed Sep. 30, 2003, the entirety of which is hereby incorporated herein by reference.

### FIELD OF THE INVENTION

This invention generally relates to an interfolding machine having a tucker assembly for folding sheets of material, and more specifically, to a feature for preventing an accumulation of dust and debris in a tucker assembly of an interfolding machine.

### BACKGROUND OF THE INVENTION

Folding of sheets of material (e.g., paper, napkins, paper towels, tissue, etc.) is frequently performed using a pair of folding rolls that have interacting mechanical gripper and tucker assemblies. The gripper and tucker assemblies are uniformly spaced around a circumference of each respective folding roll to interact with one another so as to interfold the sheets of material. The tucker assemblies on one roll interact with the gripper assemblies of the adjacent roll, and vice versa, to alternately grip and tuck successive sheets of material fed between the rolls. As the rolls rotate, the gripper assemblies carry and release the folded sheets of material to create a zigzagged interfolded stack of sheets.

Typically, the interfolding machine generates dust from the cutting and processing of the sheets of material into the finished product. The dust tends to settle in and around the various components of the interfolding machine. While the presence of dust is does not effect operation of certain components of the interfolding machine, dust buildup on other components such as bearings and the movable components of a tucker assembly can adversely effect performance of such components and therefore inhibit overall performance of the machine. For example, dust buildup in the tucker assemblies can prevent the desired movement of the tucker member of the tucker assembly when it strikes the anvil of a mating gripper assembly, or can cause mislocation of the tucker member so that the tucker member does not impact the anvil of the gripper assembly in the desired orientation. The application of lubrication to various machine components can further enhance dust accumulation. In addition, the dust accumulation on certain components of the machine can cause downtime for cleaning and maintenance, and lead to premature failure and replacement of such components. There is thus a need for an interfolding machine that is capable of reducing the accumulation of dust and debris, particularly in the area of the tucker assemblies.

### SUMMARY OF THE INVENTION

In accordance with the present invention, there is provided an interfolding machine with a folding roll having a tucker assembly configured to interact with a gripper assembly of an adjacent folding roll for gripping and folding sheets of material to form a zig-zagged stack of interfolded sheets. The tucker assembly generally includes a tucker positioned in a slot in the folding roll. The tucker assembly further includes an axial air passage disposed along a central axis of the folding roll, and one or more radial passages that extend from the axial air passage to the slot containing the tucker. The axial air passage is configured to receive and communicate a flow of pressurized air to the radial passages. The radial passages are configured to direct the flow of air in a radial outward direction along the slot. The disposition of the tucker in the slot is configured to maintain the positive air pressure about the components of the tucker assembly, to inhibit the buildup of dust and debris on the components of the tucker assembly.

The folding roll preferably includes a roll journal at one end to receive the flow of air. The axial passage extends from the roll journal to the opposite end face of the folding roll. The tucker assembly further includes a spring retainer in combination with a spring configured to bias the tucker in a radial outward direction from the slot of the folding roll. The radial passage extends radially from the axial passage to the bottom of the slot within which the spring retainer is located. The flow of air can be either constant or intermittent. The tucker assembly further includes a base portion that is received with minimal clearance in the slot such that flow of air through the radial passages creates a positive air pressure surrounding the components of the tucker assembly. The tucker assembly further includes a cap positioned to retain the tucker in the slot against a biasing force applied by the spring. The cap engages an inner surface of an outer section of the folding roll to maintain the tucker of the tucker assembly in position.

In accordance with another aspect of the invention, an interfolding machine includes a folding roll having a slot disposed along a circumference of the folding roll, and a tucker assembly with a tucker disposed in the slot of the folding roll. The folding roll further includes an axial air passage disposed along a central axis defined by the folding roll. The axial air passage is configured to receive air introduced into the axial air passage under pressure though an inlet in the folding roll. A second passage, which is oriented generally radially, extends from the axial air passage to the slot. The flow of air is directed in a radial outward direction along the slot. The disposition of the tucker in the slot is configured to create positive air pressure around the components of the tucker assembly, to inhibit debris from contaminating and interfering with operation of the tucker assembly.

In accordance with yet another aspect of the present invention, there is provided a method of inhibiting debris from contaminating the components of a tucker assembly disposed in a slot of a folding roll that generally rotates about a roll journal. The method includes the acts of providing a flow of pressurized air from an air supply to the roll journal; transmitting the flow of pressurized air from the roll journal through a passage disposed along a central axis of the roll; radiating the flow of pressurized air from the passage along the central axis of the roll to a slot arrangement in which the tucker assembly is retained; discharging the flow of air in a radial outward direction along the slot; creating a positive air pressure about the components of the tucker assembly disposed in the slot, so that the positive air pressure reduces buildup of dust and other debris that may otherwise accumulate on and around the components of the tucker assembly.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout. In the drawings:

FIG. 1 is an isometric view of an interfolding machine employing a folding roll incorporating a pressurized air dust and debris buildup prevention system in accordance with the present invention.

FIG. 2 is a schematic side elevation view of the interfolding machine shown in FIG. 1.

FIG. 3 is an enlarged partial side elevation view showing the folding rolls of the interfolding machine shown in FIG. 2, which incorporate the dust and debris accumulation prevention system in accordance with the invention.

FIG. 4 is a detailed cross-sectional view of a tucker assembly incorporated into a first one of the folding rolls shown in FIG. 3, showing the tucker assembly in an extended position.

FIG. 5 is a partial cross-sectional view along line 5-5 of FIG. 4.

FIG. 6 is a detailed isometric view of a spring retainer incorporated into the tucker assembly as shown in FIG. 5.

### DETAILED DESCRIPTION OF THE PREFERRED EMBODIMENTS

1. Interfolding Machine

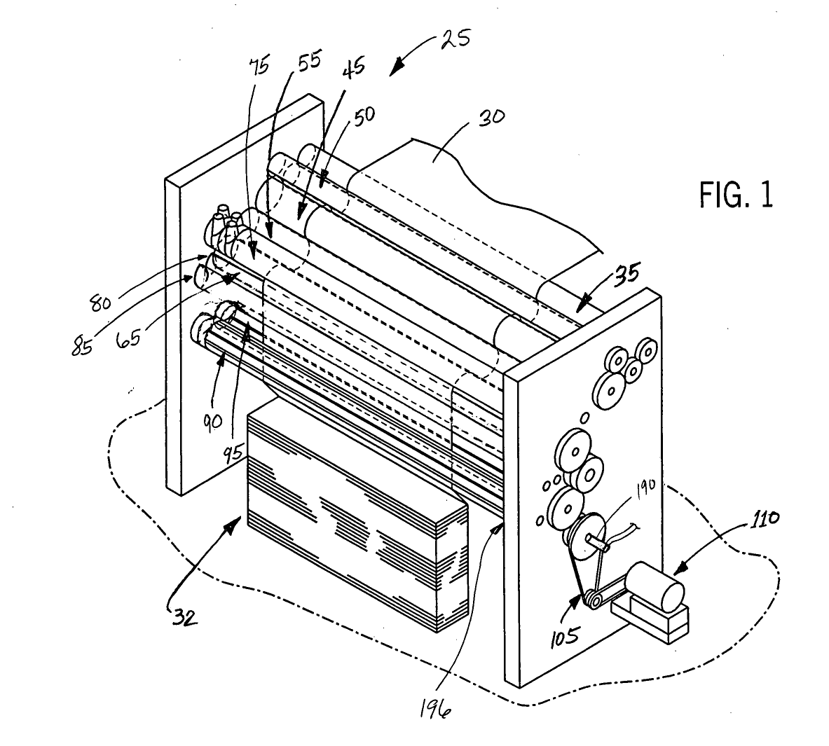

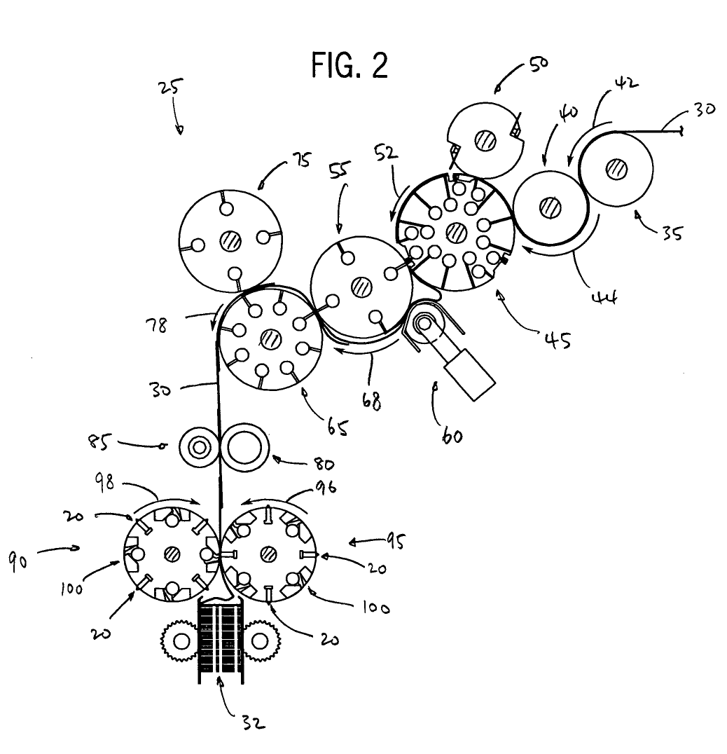

Referring to FIGS. 1 and 2, an interfolding machine 25 is operable to convert a web of material 30 into a stack of interfolded sheets of material shown at 32. Interfolding machine 25 incorporates folding rolls incorporating the pressurized dust and debris accumulation prevention system of the present invention, and generally includes a first pull roll 35 and a second pull roll 40 that receive the web of material 30 along a path (illustrated by an arrow 42 in FIG. 2) from a supply roll (not shown) into the interfolding machine 20. The first and second pull rolls 35 and 40 define a nip through which the web of material 30 passes, and function to unwind the web of material 30 and feed the web of material 30 in a path (illustrated by an arrow 44 in FIG. 2) toward a nip defined between second pull roll 40 and a bed roll 45. The web of material 30 is then advanced by bed roll 45 toward a knife roll 50. In a manner as is known, the knife roll 50 cuts the web of material 30 into sheets, each of which has a predetermined length, and the bed roll 45 carries the sheets of material along a path (illustrated by arrow 52 in FIG. 2) toward and through a nip defined between bed roll 45 and a retard roll 55, which rotates at a slower speed of rotation than the bed roll 45. In a manner as explained in copending application serial number ______ filed ______(atty docket no. 368.033), the retard roll 55 cooperates with a nip roller assembly 60 (FIG. 2) to form an overlap between the consecutive sheets of material. The retard roll 55 carries the overlapped sheets of material along a path (illustrated by arrow 68 in FIG. 2) to a lap roll 65.

The lap roll 65 works in combination with a count roll 75 to eliminate the overlap between adjacent sheets of material at a predetermined sheet count, so as to create a separation in the stack 32 of interfolded sheets discharged from the interfolding machine 25. The lap roll 55 carries the overlapped sheets of sheet 30 along a path (illustrated by arrow 78 in FIG. 2) toward a nip defined between a first assist roll 80 and an adjacent second assist roll 85. The first and second assist rolls 80 and 85 feed the sheets of the material to a nip defined between a first folding roll 90 and a second folding roll 95.

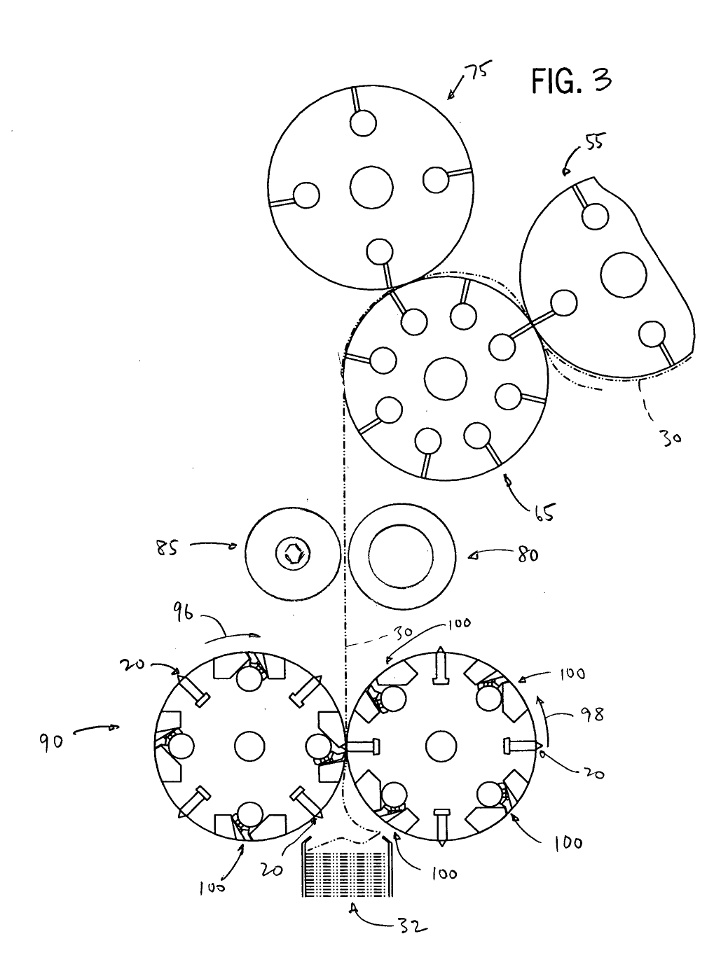

Referring to FIGS. 2 and 3, the first and second folding rolls 90 and 95 generally rotate in opposite directions (illustrated by arrows 96 and 98, respectively) to receive the overlapped sheets of web material 30 therebetween. The periphery of the first folding roll 90 generally includes a series of the gripper assemblies 100 and a series of tucker assemblies 20, which incorporate the pressurized dust and debris buildup prevention system of the present invention, and which are uniformly and alternately spaced to interact with a series of gripper assemblies 100 and tucker assemblies 20 of the adjacent second folding roll 95. The series of alternately spaced gripper assemblies 100 and tucker assemblies 20 of the first and second folding rolls 90 and 95 interact to grip, carry, and release the sheets of material in a desired manner so as to form the desired interfolded relationship in the sheets of material and to form stack 32 of interfolded sheets. The folding rolls 90 and 95 may be driven by a drive system 110 having a drive belt assembly 115 (FIG. 1).

The stack 32 of interfolded sheets is discharged from between the first and second folding rolls 90 and 95 in a generally vertically-aligned fashion. The stack 32 of interfolded sheets may be supplied to a discharge and transfer system (not shown), which guides and conveys the stack 32 from the generally vertically-aligned orientation at the discharge of the interfolding machine 25 to a generally horizontally-aligned movement. One embodiment of a suitable discharge and transfer system is described in U.S. Pat. No. 6,712,746 entitled “Discharge and Transfer System for Interfolded Sheets,” filed May 5, 2000, the disclosure of which is hereby incorporated herein by reference in its entirety. Another representative discharge and transfer system is illustrated in copending application serial no. ______ filed ______(atty docket no. 368.005), the disclosure of which is also hereby incorporated herein by reference in its entirety.

2. Tucker Assembly with Pressurized Dust and Debris Accumulation Prevention System

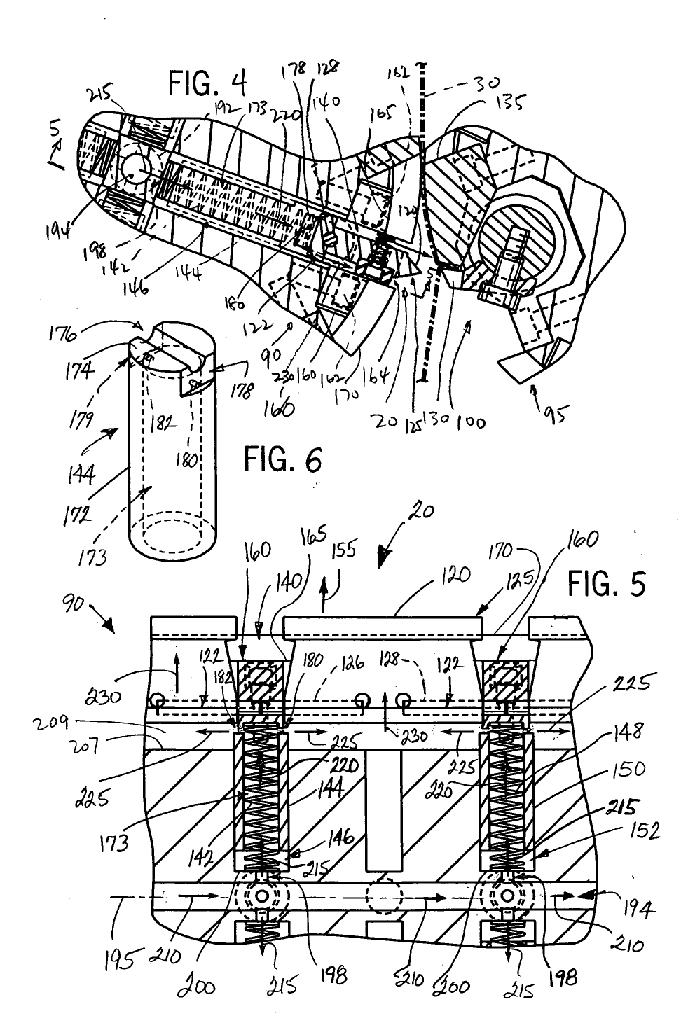

FIGS. 4 and 5 illustrate a detailed cross-sectional view of one embodiment of a tucker assembly 20 of the first folding roll 90 interacting with the gripper assembly 100 of the adjacent second folding roll 95 (See FIG. 3). It is understood that the other alternating tucker assemblies 20 and gripper assemblies 100 of the first and second folding rolls 90 and 95 interact in a similar manner. In the illustrated embodiment, tucker assembly 20 generally includes a tucker 120 having a base portion 122 opposite a pointed end 125 to engage the recessed gripper assembly 100 of the adjacent roll 95. Gripper assembly 100 may have a construction as shown and described in copending application serial no. ______ filed ______(atty docket no. 368.028), the disclosure of which is hereby incorporated by reference.

Tucker assembly 20 further includes a first tucker bearing pin 126 and a second tucker bearing pin 128 which cooperate to pivotally support the tucker 120 in a radially extending slot 140 in folding roll 90. As the sheets 30 flow between the folding rolls 90 and 95, the tucker assembly 20 is configured to tuck the sheet of material 30 between a blade 130 and an anvil 135 of the gripper assembly 100.

Tucker 120 of tucker assembly 20 is formed in sections along the length of folding roll 90. In addition to the sections of tucker 120, each tucker assembly 20 further includes a series of springs and spring retainers along its length. As shown in FIGS. 4 and 5, the springs and spring retainers include a first spring 142 and a first spring retainer 144 disposed in a slot 146, and a second spring 148 and a second spring retainer 150 disposed in a slot 152. Additional similarly constructed springs and spring retainers are located along the length of tucker assembly 20. The springs such as 142 and 148 in combination with the spring retainers such as 144 and 150, respectively, bias the sections of tucker 120 in a radial outward direction (illustrated by arrow 155 in FIG. 5) along the slot 140. A cap 160 retains the tucker assembly 20 in the slot 140 against the bias of the springs such as 142 and 148 and the associated spring retainers such as 144 and 150, respectively. The cap 160 is retained in position via threaded fasteners such as screws 162, and faces an inner surface 165 of an outer roll wall 170, which includes an opening or slot through which tucker 120 extends so that the tip of tucker 120 is located outwardly of the outer surface of roll 90.

FIG. 6 illustrates a preferred embodiment of spring retainer 144, which is in the form of a generally cylindrical structure 172 that defines an interior passage 173 to receive the spring 142 therein. The generally cylindrical structure 172 further includes a top surface 174 that overlies an internal passage 173 of cylindrical structure 172, and which has an arcuate recess 176 that receives a tucker roll pin or bearing pin 128 (see FIGS. 4 and 5). In a manner as is fully explained in copending application serial no. ______ filed ______, (atty docket no. 368.023), the disclosure of which is herby incorporated by reference, roll pin or bearing pin 128 defines a pivot axis about which tucker 120 is pivotable. A transversely oriented centering spring assembly 164 engages tucker 120 to resiliently center tucker 120 within the opening or slot in outer roll wall 170.

The cylindrical structure 172 of the first spring retainer 144 further includes a first cutout portion 178 opposite a second cutout portion 179 at or near the top surface 174. The first and second cutout portions 178 and 179 are generally flat, to receive an adjacent flat face defined by the base portion 122 of the tucker 120. A first opening 180 is located between the internal passage 173 and the first cutout portion 178, and a second opening 182 is located between the internal passage 173 and the second cutout portion 179. The first and second openings 180 and 182 communicate the internal passage 173 of the cylindrical structure 172 with cavities defined by the first and second cutout portions 178 and 179 (see FIGS. 4 and 5). The spring retainer 150 is constructed in a similar manner to the spring retainer 144, and therefore is not described in detail.

The folding roll 90 is rotatably mounted to a frame or other support structure via a rotary joint 190 (FIG. 1) affixed to an end of a roll journal 192 (shown in dashed lines in FIG. 2). The roll journal 192 receives a flow of pressurized air via the rotary joint 190 from an external pressurized air source (e.g., a compressor, fan, etc.), not shown. The flow of pressurized air passes from the roll journal 192 and along a central axial passage 194 (FIGS. 4, 5) extending along a central longitudinal axis 195 of the folding roll 90. The central axial passage 194 extends from the journal 192 throughout the length of folding roll 90 to the opposite end of the roll adjacent a support member 196 (FIG. 1). The central axial passage 194 is connected in communication with a series of smaller radial openings or holes 198, which extend radially from the central axial passage 194 and open onto the bottom 200 of the cavities or passages 146 and 152 within which the spring retainers 144 and 150 are located. The radial holes 198 allow the flow of pressurized air to travel in a radial outward direction into the interior passage (such as 173) formed in the spring retainers 144 and 150.

Still referring to FIGS. 4 and 5, the base portion 122 of the tucker 120 fits snugly in the slot 140, and cooperates with an outwardly facing inner surface 207 of folding roll 90 to form a laterally extending passage 209, within which the upper ends of the spring retainers, such as 144 and 150, are located. In this manner, holes 180, 182 are in communication with laterally extending passage 209, such that a small amount or flow of pressurized air passes through the holes 180 and 182 at or near the end of the spring retainers such as 144, 150. In this manner, the sections of tucker 120 between the spring retainers such as 144,150 generally covers passage 209, which maintains the pressure of the air supplied to passage 209. Such supply of pressurized air to passage 209 provides a flow of pressurized air about the tucker 120 and tucker bearing pin 128. The air flow about tucker 120 and tucker bearing pins 128 provided by the positive air pressure in passage 209 deters or inhibits dust or other foreign material from entering the spaces around the tucker 120 and tucker bearing pin 128, and thus reduces dust build-up around the tucker 120 and tucker bearing pin 128. In the preferred embodiment, the positive pressure of the flow of air is preferably constant. In an alternative embodiment, the flow of air can be pulsed or intermittent. The flow rate and pressure of the flow of air through the axial passage 194 and the holes 198 can vary.

In operation, the tucker assemblies 20 interact with the gripper assemblies 100 so as to grip and carry the sheets of material. The tuckers 120 of the tucker assemblies 20 are generally biased in a radial outward direction 155 by springs 142 and 148. The external pressurized air source provides the flow of air to the folding rolls 90 and 95. The axial passage 194 transmits the flow of air (illustrated by arrow 210 in FIG. 5) along the central axis 195 of the folding roll 190 to the series of openings 198, which in turn supply the pressurized air to passages 198 that radiate the flow of air (illustrated by arrows 215) from the passage 194 to the passages 146 and 152 which retain the spring retainers 144 and 150, respectively. The interior passages 173 of the retainers such as 144 communicate the flow of air in the radial outward direction (illustrated by arrow 220) and to openings 180 and 182 at the opposite end of the spring retainer 144. The openings 180 and 182 pass the flow of air (illustrated by arrows 225) to the passage 209 defined below base 122 of the tucker 120. The pressure of the air within the passage 209 results in the outward flow of air (illustrated by arrow 230) around the tucker 120 disposed in the slot 140. The positive air pressure reduces the buildup or accumulation of dust or debris around the components of tucker 120.

A wide variety of machines or systems could be constructed in accordance with the invention defined by the claims. Hence, although the exemplary embodiment of a tucker assembly 20 (See FIGS. 3-6) in accordance with the invention will be generally described with reference to an interfolding machine 25 (See FIGS. 1 and 2) for folding sheets formed from a web material 30 into a zig-zagged stack 32 of web material 30, as shown in FIG. 1, the application of the tucker assembly 20 is not so limited. The tucker assembly 20 of the invention could be employed to tuck and release any type of sheet or web-material 30 being fed for a wide variety of uses by various machines and is not limiting on the invention. In addition, it should be understood that the supply of pressurized air to and around the tucker assembly may be provided by any satisfactory arrangement of passages in the folding roll 90 below the tucker assembly, to provide the discharge of pressurized air outwardly around the components of the tucker assembly.

The above discussion, examples, and embodiments illustrate our current understanding of the invention. However, since many variations of the invention can be made without departing from the spirit and scope of the invention, the invention resides wholly in the claims hereafter appended.

1. A folding roll having a tucker assembly with a tucker configured to interact with a gripper assembly of an adjacent folding roll for gripping a web material, comprising:
a cavity to receive the tucker assembly;
an axial air supply passage that receives a pressurized air from a pressurized air source; and
passage means extending from the axial passage to the cavity, wherein air from the air supply passage is directed outwardly into the cavity, wherein the tucker is configured to create positive air pressure around the tucker that results in the flow of air outwardly around the components of the tucker to prevent the buildup of dust and debris on the tucker assembly.

2. The folding roll as recited in claim 1, further comprising a roll journal to receive the pressurized air from the pressurized air source.

3. The folding roll as recited in claim 2, wherein the axial air supply passage extends from the roll journal along a central axis of the folding roll.

4. The folding roll as recited in claim 1, wherein the tucker assembly includes a spring retainer having a spring located within a passage, and wherein the passage means communicates the flow of air from the axial passage to a bottom of the spring retainer.

5. The folding roll as recited in claim 4, wherein the spring retainer is a generally cylindrical structure that defines a hollow passage to receive the flow of air from the passage means.

6. The folding roll as recited in claim 5, wherein the cylindrical structure includes a first opening and a second opening generally aligned perpendicular to and in communication to receive the flow of air from the hollow passage, and wherein the tucker of the tucker assembly cooperates with an internal surface defined by the folding roll to define a lateral passage that receives the pressurized air from the first and second openings.

7. The folding roll as recited in claim 6, wherein the cylindrical structure includes a first cutout portion and a second cutout portion opposite the first cutout portion, the first opening in communication with the first cutout portion and the second opening in communication with the second cutout portion.

8. The folding roll as recited in claim 1, wherein the tucker includes a base portion that is received with minimal clearance in the cavity such that flow of air through the passage means creates a positive air pressure surrounding the tucker.

9. The folding roll as recited in claim 1, further comprising a cap to retain the tucker in the cavity against a bias of a spring that urges the tucker outwardly of the cavity.

10. An interfolding machine, comprising:
a folding roll having a cavity disposed along a circumference of the roll;
a tucker assembly with a tucker disposed in the cavity of the folding roll;
an axial passage disposed along a central axis of the folding roll, the axial passage configured to receive a flow of pressurized air from a pressurized air source;
an outwardly extending passage arrangement extending from the axial passage to the cavity,
wherein the flow of air is directed in a radial outward direction along the cavity, and wherein the disposition of the tucker in the cavity is configured to create positive air pressure around the tucker.

11. The interfolding machine as recited in claim 10, further comprising a rotary joint to receive the flow of pressurized air to the folding roll.

12. The interfolding machine as recited in claim 10, wherein the axial passage extends along a central axis of the folding roll.

13. The interfolding machine as recited in claim 10, wherein the tucker assembly includes a spring retainer with a spring, and wherein the outwardly extending passage arrangement communicates the flow of air from the axial passage to a bottom of the spring retainer, and wherein the spring retainer is a generally cylindrical structure that defines a hollow passage to receive the flow of air from the outwardly extending passage arrangement.

14. The interfolding machine as recited in claim 13, wherein the cylindrical structure includes a first opening and a second opening generally aligned perpendicular to and in communication to receive the flow of air from the hollow passage.

15. The interfolding machine as recited in claim 14, wherein the cylindrical structure includes a first cutout portion and a second cutout portion opposite the first cutout portion, the first opening in communication with the first cutout portion and the second opening in communication with the second cutout portion.

16. The interfolding machine as recited in claim 10, wherein the tucker includes a base portion that is received with minimal clearance in the cavity such that flow of air through the outwardly extending passage arrangement creates positive air pressure surrounding the tucker.

17. A method of inhibiting debris from contaminating a tucker of a tucker assembly disposed in a cavity of a folding roll, the roll rotating about a roll journal, the method comprising the acts of:
providing a flow of air from an air supply;
transmitting the flow of air along an air supply passage disposed along a central axis of the folding roll;
radiating the flow of air from the air supply passage through a plurality of radial passages;
routing the flow of air outwardly into the cavity; and
creating positive air pressure in the cavity against the tucker, wherein the positive air pressure reduces buildup of dust and debris around the tucker.

18. The method as recited in claim 17, further comprising:
retaining the tucker in the cavity with a cap against a bias applied by a spring.

19. The method as recited in claim 17, wherein the flow of air is constant.

20. The method of claim 17, wherein the flow of air is intermittent.
